(19) United States
(12) Patent Application Publication
(10) Pub. No.: US 2004/0240892 A1
(43) Pub. Date: Dec. 2, 2004

(54) Method and apparatus for detecting interruption of an input signal

(76) Inventors: Cindra W. Abidin, Los Angeles, CA (US); Georgios Asmanis, North Hollywood, CA (US)

Correspondence Address: BUCKLEY, MASCHOFF, TALWALKAR LLC, 5 ELM STREET, NEW CANAAN, CT, 06840, US

(21) Appl. No.: 10/445,757

(22) Filed: May 27, 2003

(51) Int. Cl. H04B 10/06

(52) U.S. Cl. 398/214

(57) ABSTRACT

A first amplifier receives an input signal and outputs an amplified input signal. A peak detector receives the amplified input signal and outputs a signal that represents a peak level of the amplified input signal. A threshold generator generates a threshold signal. A second amplifier receives the threshold signal and outputs an amplified threshold signal. A comparator compares the signal output from the peak detector with the amplified threshold signal to detect loss of the input signal.

### BACKGROUND

Devices such as optical transceivers, limiting amplifiers and transimpedance amplifiers often include a circuit arrangement to detect interruption of an input signal. Such a circuit arrangement is referred to as a “loss-of-signal” (LOS) detector. Conventional LOS detectors typically require an off-chip adjustable component, such as a variable resistor, to allow for compensation for gain variations in on-chip circuitry. The provision of the off-chip adjustable component, and the labor required for adjustment, increase the cost of manufacturing the device of which the LOS detector is a part.

### BRIEF DESCRIPTION OF THE DRAWINGS

FIG. 1 is a block diagram of a data processing or storage apparatus according to some embodiments.

FIG. 2 is a partial block diagram representation of an optical transceiver that is part of the apparatus of FIG. 1.

FIG. 3 is a schematic representation of a semiconductor die on which at least a portion of the optical transceiver is formed.

FIG. 4 is a schematic circuit diagram of an LOS detector according to some embodiments.

FIG. 5 is a schematic circuit diagram that illustrates a two-stage construction of input and threshold amplifiers that are part of the LOS detector of FIG. 4.

FIG. 6 is a schematic circuit diagram that illustrates a typical one of the amplifier stages of FIG. 5.

FIG. 7 is a schematic circuit diagram that illustrates a peak detector that is part of the LOS detector of FIG. 4.

FIG. 8 is a schematic circuit diagram that illustrates a comparator that is part of the LOS detector of FIG. 4.

FIG. 9 is a flow chart that illustrates functions performed by the LOS detector of FIG. 4.

FIG. 10 is a schematic circuit diagram of an LOS detector according to some other embodiments.

FIG. 11is a schematic circuit diagram that illustrates a threshold amplifier that is part of the LOS detector of FIG. 10.

### DETAILED DESCRIPTION

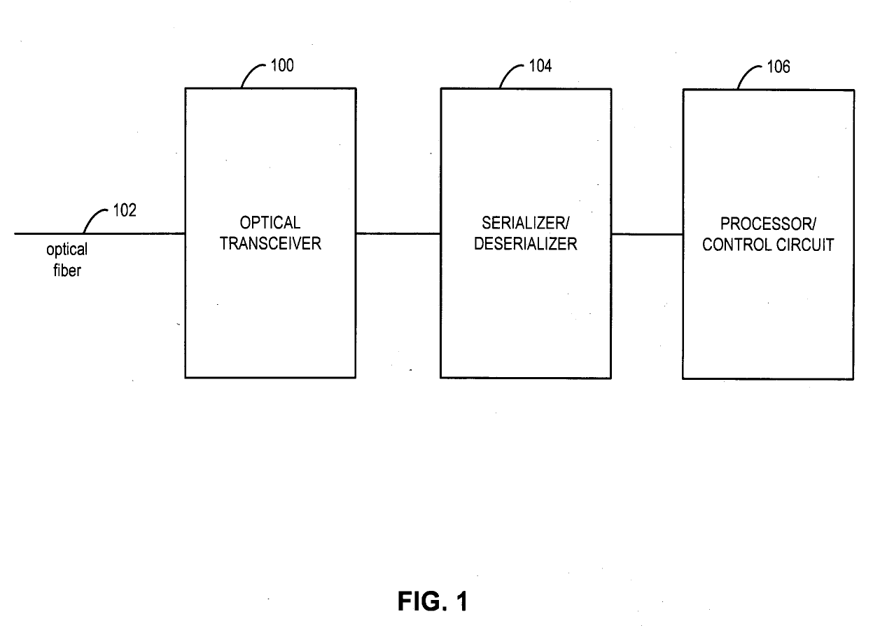

FIG. 1 is a simplified block diagram of a data processing or storage apparatus according to some embodiments. The apparatus of FIG. 1 includes an optical transceiver 100 coupled to an optical communication fiber 102. A serializer/deserializer 104 couples the optical transceiver 100 to a processor or control circuit 106. The processor or control circuit 106 and the serializer/deserializer 104 may both be conventional devices. The serializer/deserializer 104 may be integrated with the optical transceiver 100.

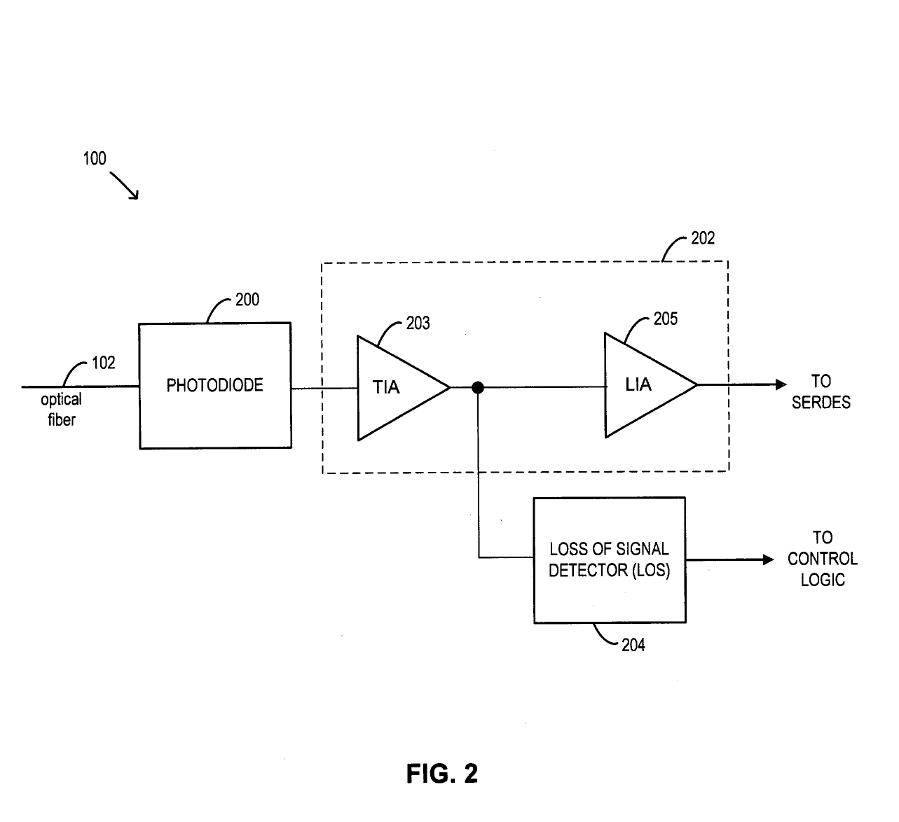

FIG. 2 is a partial block diagram of the optical transceiver 100 shown in FIG. 1.

The optical transceiver 100 includes a photodiode 200 coupled to the optical fiber 102 to receive an optical input signal and to convert the optical input signal to an electrical input signal. The optical transceiver 100 also includes a receive amplifier 202 that is coupled to the photodiode 200 to receive the electrical input signal and to amplify the electrical input signal. The amplified input signal is provided from the receive amplifier 202 to the serializer/deserializer 104 (FIG. 1) which converts the amplified input signal to parallel form. The resulting parallel input signal is provided to the processor or control circuit 106. Hence the processor or control circuit 106 is coupled to the receive amplifier 202 to receive input signals via the receive amplifier 202 and the serializer/deserializer 104.

The photodiode 200 and the receive amplifier 202 may be provided in accordance with conventional practices. The receive amplifier 202 may include a conventional transimpedance amplifier 203 coupled to the photodiode 200 to receive the electrical input signal, and a conventional limiting amplifier 205 coupled to the output of the transimpedance amplifier 203. The limiting amplifier 205 provides the amplified input signal to the serializer/deserializer 104 (FIG. 1).

Also included in the optical transceiver 100 is an LOS detector 204 provided according to some embodiments. The LOS detector 204 is coupled to the photodiode 200 to receive the electrical input signal via the transimpedance amplifier 203. As will be seen, the LOS detector 204 is arranged to detect when the input signal is interrupted. When this occurs, the LOS detector 204 outputs a suitable signal to control logic (which is not shown) so that the control logic can take suitable steps such as initiating system re-initialization and/or debugging procedures.

According to alternative arrangements of the optical transceiver 100, the LOS detector 204, as described below, may be modified so as to be suitable for receiving the current signal output from the photodiode 200 and may be coupled directly to the photodiode 200. According to other alternative arrangements, the LOS detector 204 may be coupled to receive an intermediate signal from the transimpedance amplifier 203, if the transimpedance amplifier 203 has more than one gain stage.

To simplify the drawing, certain elements of the optical transceiver, including those associated with a signal transmission (outbound) path, are omitted. These elements may be provided in accordance with conventional practices.

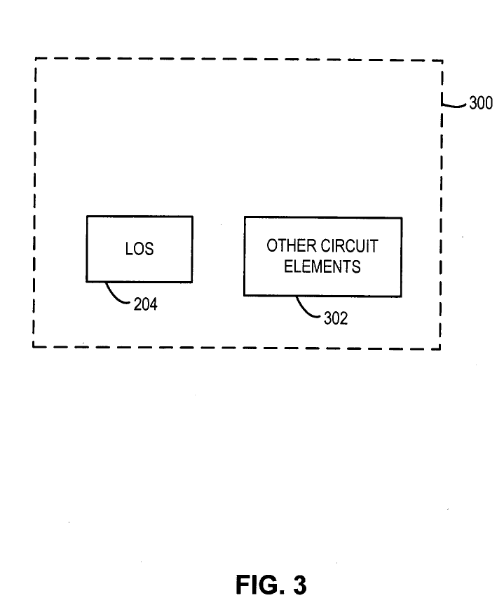

FIG. 3 is a schematic representation of a semiconductor die 300 on which at least a portion of the optical transceiver 100 (FIGS. 2 and 3) is formed. The circuit elements formed on the semiconductor die 300 include the LOS detector 204 and other elements 302 of the optical transceiver 100.

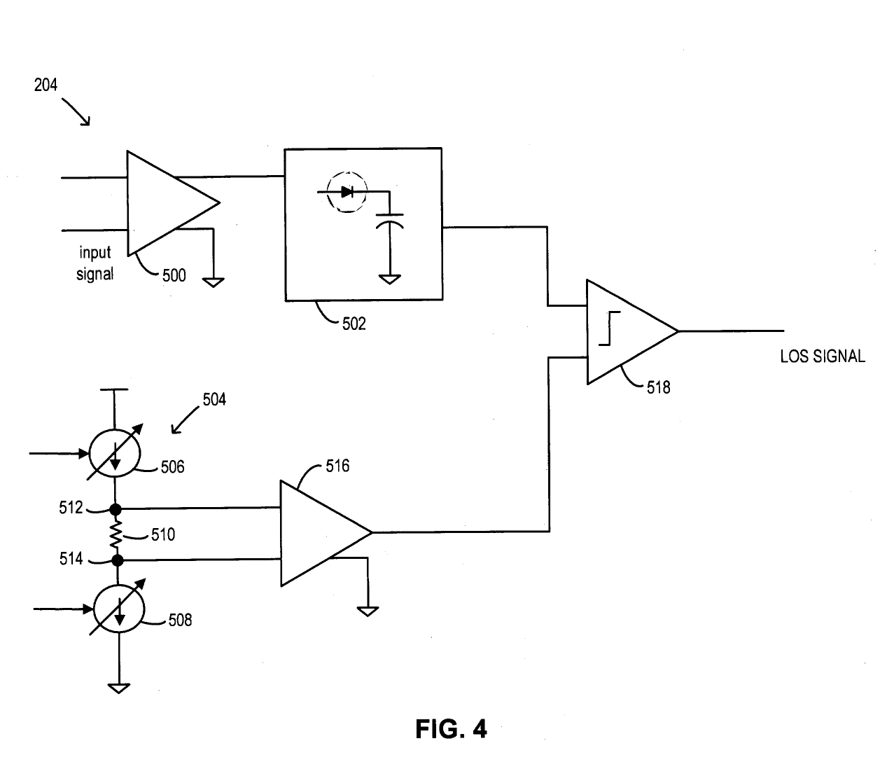

FIG. 4 is a schematic circuit diagram that illustrates an LOS detector 204 provided according to some embodiments.

The LOS detector 204 includes an input amplifier 500 coupled to the photodiode 200 (FIG. 2) to receive the electrical input signal provided by the photodiode. The input amplifier 500 outputs an amplified input signal.

Also included in the LOS detector 204 is a peak detector 502 that is coupled to the input amplifier 500 to receive the amplified input signal. As will be seen, the peak detector outputs a peak level signal that represents a peak level of the amplified input signal.

The LOS detector 204 also includes a programmable threshold generator 504. The threshold generator 504 may include variable current sources 506, 508 coupled to each other in series via a resistor 510. Programming signals may be applied to the variable current sources 506, 508. The threshold generator 504 generates a threshold signal or signals taken out from nodes 512, 514 at either end of the resistor 510.

The LOS detector 204 further includes a threshold amplifier 516. The threshold amplifier 516 is coupled to the threshold generator 504 to receive the threshold signals generated by the threshold generator. The threshold amplifier 516 outputs an amplified threshold signal. In some embodiments, the threshold amplifier 516 is formed on the same semiconductor die 300 (FIG. 3) as the input amplifier 500 and is configured to substantially match a gain provided by the input amplifier 500. Also, the gain of the threshold amplifier 516 may track the gain of the input amplifier 500 over process, supply voltage and temperature (PVT) variations.

The LOS detector 204 also includes a comparator 518 coupled to the peak detector 502 and to the threshold amplifier 516. The comparator 518 compares the peak level signal output from the peak detector 502 to the amplified threshold signal output from the threshold amplifier 516. On the basis of the comparison, the comparator 518 may output an LOS signal. For example, the comparator 518 may output the LOS signal in the event that the peak level signal is less than the amplified threshold signal.

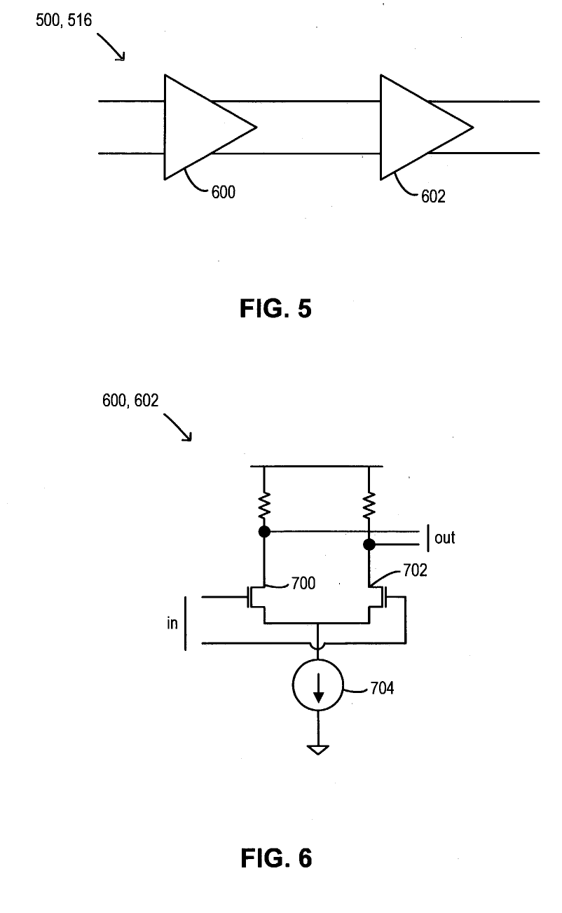

The respective configurations of the input amplifier 500 and the threshold amplifier 516 may be substantially the same in some embodiments. FIG. 5 is a high-level schematic illustration of the common configuration of the amplifiers 500, 516. As seen from FIG. 5, each of the amplifiers 500, 516 may be formed in two cascaded amplifier stages, namely an input stage 600 and an output stage 602.

FIG. 6 is a schematic circuit diagram that illustrates the construction in MOSFET circuitry, according to some embodiments, of either or both of the amplifier stages 600, 602 shown in FIG. 5. The amplifier stages 600 and/or 602 may be formed as a differential pair with field effect transistors 700, 702 biased by a current source 704.

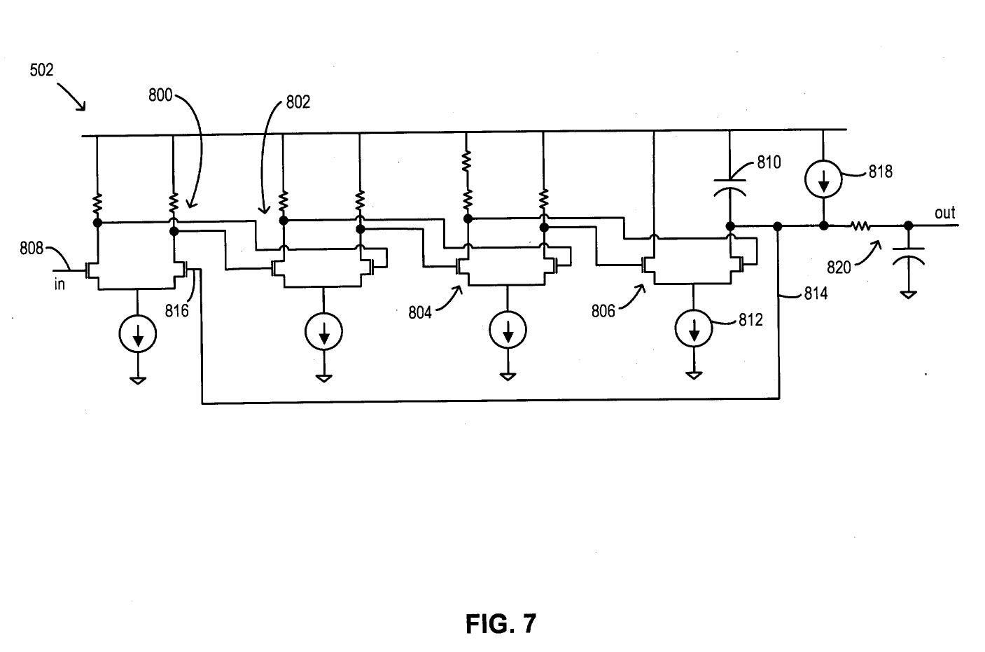

FIG. 7 is a schematic circuit diagram that illustrates the peak detector 502 shown in FIG. 4, as provided using CMOS technology according to some embodiments.

As shown in FIG. 7, the peak detector 502 includes four stages: (1) a first balanced differential pair 800, (2) a second balanced differential pair 802 coupled to the first balanced differential pair 800, (3) an unbalanced differential pair 804 coupled to the second balanced differential pair, and (4) a final stage differential pair 806 coupled to the unbalanced differential pair 804. An input 808 of the first balanced differential pair is coupled to the input amplifier 500 (FIG. 4) to receive the amplified input signal from the input amplifier.

A capacitor 810 is coupled to the drain of the right branch of the final stage differential pair 806. The capacitor 810 may be implemented as a CMOS capacitor (e.g., PMOS with source, drain and bulk) connected to the power supply, as is a known technique of digital CMOS technology. The capacitor 810 may alternatively be implemented as an MIM (Metal Insulator Metal) capacitor.

A current source 812 is associated with the final stage differential pair 806 to charge the capacitor 810 when an input signal is present at the LOS detector 204. A feedback connection 814 couples the output of the final stage differential pair 806 to a second input 816 of the first balanced differential pair 800. A current source 818 is connected between the power supply and the output of the final stage differential pair 806. The output of the final stage differential pair 806 is coupled to an input of the comparator 518 (FIG. 4) via an RC lowpass filter 820 (FIG. 7).

The first and second balanced differential pairs 800, 802 provide the gain required for the peak detector 502. Instead of the two gain stages shown, more or fewer gain stages may be provided. Because of the feedback connection 814 from the output of the final stage differential pair 806 to the first balanced differential pair 800, the total gain of the peak detector 502 is unity.

The unbalanced stage 804 is provided to block current from the current source 812 once the peak of the input signal has been detected at the output of the peak detector 502. At that time, the current source 812 will be bypassed to the left branch of the final stage 806 and consequently will not charge or discharge the capacitor 810. When an input signal is present at the input of the peak detector 502 and the voltage at the output of the final stage differential pair 806 is larger than the negative peak of the input signal, the capacitor 810 is charged by the current source 812 and discharged by the current source 818. Therefore, the magnitude of the current source 812 determines the rate of charging of the capacitor 810 and the magnitude of the current source 818 determines the rate of discharging the capacitor 810. The capacitor 810 will only be charged by the current source 812 if the signal level at the output of the final stage differential pair 806 is greater than the negative peak of the signal present at the input of the peak detector 502, and the signal at the input of the peak detector 502 is less than the DC level at the output of the peak detector 502.

The RC filter 820 is provided at the output of the final stage differential pair 806 to extract the DC component. Charging or discharging is always occurring at the output of the final stage differential pair 806, so the RC filter is provided to block high frequency signal components.

According to some alternative arrangements of the peak detector 502, the second stage may be unbalanced rather than the third stage.

According to some embodiments, either or both of the variable current sources 506, 508 of the threshold generator 504 may be programmed to change the threshold in such a manner as to adapt the LOS detector 204 for use in a number of different applications.

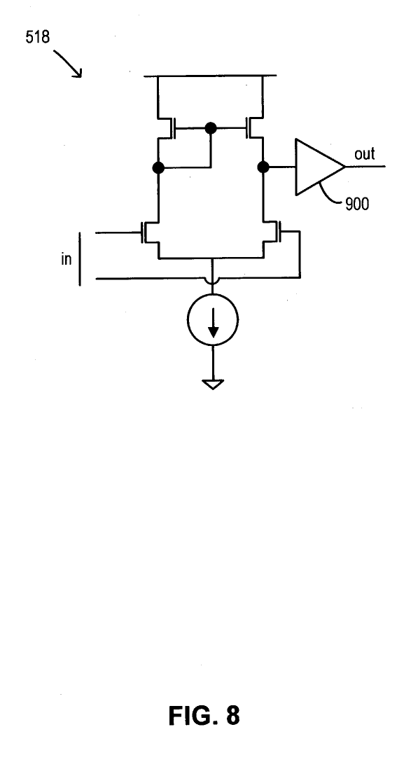

FIG. 8 is a schematic circuit diagram that illustrates the comparator 518 shown in FIG. 4, as provided using CMOS technology according to some embodiments. The comparator is formed as a single-stage differential amplifier with a current mirror active load. An inverter 900 clips the output of the comparator 518 to ground or to the power supply voltage, depending upon the logic that is employed.

Design of a suitable threshold generator 504 (FIG. 4) is easily within the abilities of those of ordinary skill in the art, and therefore need not be described herein.

In operation, the optical input signal received via the optical fiber 102 (FIGS. 1, 2) is converted to an electrical input signal by the photodiode 200 (FIG. 2). The input electrical signal is amplified by the receive amplifier 202, and the resulting amplified signal is supplied to the serializer/deserializer 104 (FIG. 1). The serializer/deserializer 104 converts the input signal to a parallel format and the parallel input signal is provided to the processor or control circuit 106.

Meanwhile, the input electrical signal from the photodiode 200 is also supplied to the LOS detector 204 (FIG. 2) and more particularly to the input amplifier 500 (FIG. 4). The input amplifier 500 outputs an amplified input signal to the peak detector 502, which detects a peak level of the amplified input signal and supplies the detected peak level to the comparator 518. At the same time, a threshold signal generated by the threshold generator 504 is amplified by the threshold amplifier 516 and the resulting amplified threshold signal is supplied to the comparator 518. The comparator 518 compares the amplified input signal peak level provided from the peak detector 502 to the amplified threshold signal provided from the threshold amplifier 516. On the basis of the comparison, the comparator 518 outputs an LOS signal when the amplified input signal peak level is such as to indicate that the input signal has been lost. The resulting LOS signal may be received by control logic which is not shown. The control logic may initiate a system reinitialization or debugging procedure or take other steps as appropriate in response to the detected loss of input signal.

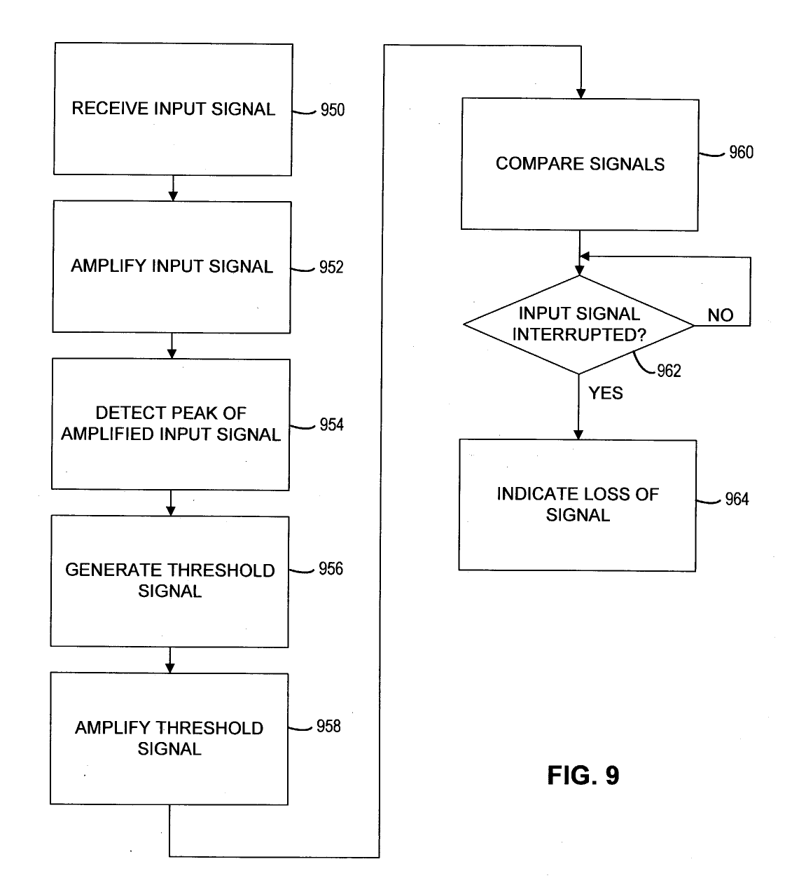

An overview of operation of the LOS detector 204 (FIG. 4) is provided by FIG. 9, which is a flow chart that illustrates functions performed by the LOS detector 204.

At 950 in FIG. 9, an input signal is received at the input amplifier 500. At 952, the input signal is amplified by the input amplifier 500. At 954, the peak detector 502 detects a peak level of the amplified input signal.

At 956, the threshold generator 504 generates a threshold signal. At 958, the threshold amplifier 516 amplifies the threshold signal.

At 960, the comparator 518 compares the peak level detected by the peak detector 502 with the amplified threshold signal. On the basis of the comparison, the comparator 518 determines whether the input signal has been interrupted (962 in FIG. 9), and if so, the comparator 518 outputs a signal to indicate loss of the input signal (964 in FIG. 9).

It should be understood that the order in which these functions is performed may not be as portrayed in FIG. 9. For example some or all of the functions may be performed simultaneously or substantially simultaneously.

The provision of the threshold amplifier 516, with a gain that tracks the gain (and any variations therein) of the input amplifier 500, results in automatic compensation for variations in gain of the input amplifier. Consequently, the prior art off-chip compensation arrangement, such as a variable resistor, can be dispensed with, thereby reducing the cost of manufacturing the optical transceiver and increasing the degree of integration of the device.

The LOS detector described above, with the gain of the input amplifier compensated by the threshold amplifier, is suitable for use in a wide variety of semiconductor fabrication technology. Also, the LOS detector described above may be incorporated in other devices in addition to optical transceivers. Such other devices may include limiting amplifiers and transimpedance amplifiers. The LOS detector described above may be provided on a separate chip or on the same chip with at least some of the circuitry of the transceiver, limiting amplifier, transimpedance amplifier or other device with which the LOS detector is associated.

In some embodiments, some or all of the threshold branch of the LOS detector 204 may be shared among a number of different input channels. The input signal peak detected by the peak detector may be a positive or negative peak. The input signal monitored by the LOS detector may be obtained from a device other than a photodiode.

In some embodiments the input amplifier 500 may not be dedicated to the LOS detector 204, but rather may be shared with the TIA 203 or the LIA 205. For example, the input amplifier 500 may be an initial, intermediate or final stage or stages of the TIA 203 or of the LIA 205, and the threshold amplifier 516 could be arranged to match the gain of such initial, intermediate or final stage or stages.

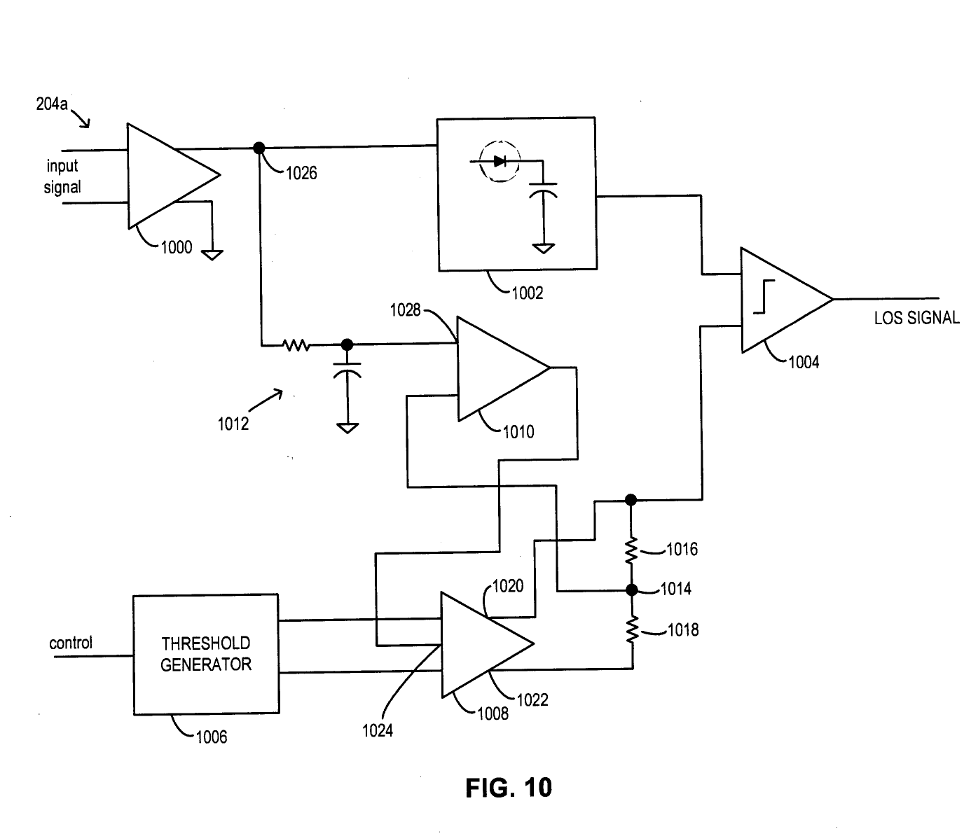

FIG. 10 is a schematic circuit diagram of an LOS detector 204a according to some other embodiments. The LOS detector design illustrated in FIG. 10 may be particularly suitable for implementation via CMOS technology.

The LOS detector 204a includes an input amplifier 1000 coupled to the photodiode 200 (FIG. 2) to receive the electrical input signal provided by the photodiode and to output an amplified input signal. The input amplifier 1000 may be the same as the input amplifier 500 described in connection with FIGS. 4-6.

The LOS detector 204a also includes a peak detector 1002 that is coupled to the input amplifier 1000 to receive the amplified input signal. The peak detector 1002 detects a peak level of the amplified output signal and outputs the detected peak level to a comparator 1004. The peak detector 1002 may be the same as the peak detector 502 described in connection with FIGS. 4 and 7. The comparator 1004 may be constituted by an operational amplifier, for example.

The LOS detector 204a further includes a threshold generator 1006 which generates a threshold signal or signals and may be the same as the threshold generator 504 of FIG. 4. Also included in the LOS detector 204a is a threshold amplifier 1008 which is coupled to the threshold generator 504, and receives and amplifies the threshold signal from the threshold generator 1006.

In addition to the above components of the LOS detector 204a, which were also generally present in the LOS detector 204 of FIG. 4, the LOS detector 204a of FIG. 10 also provides for coupling of the input and threshold branches via an operational amplifier 1010 to allow for minimizing of mismatches due to offsets in the input and threshold branches.

One input of the operational amplifier 1010 is coupled, via an RC lowpass filter 1012, to receive a DC component of the amplified input signal that is output from the input amplifier 1000. The other input of the operational amplifier 1010 is coupled to a node 1014 between resistors 1016 and 1018. The resistors 1016 and 1018 are connected in series between outputs 1020 and 1022 of the threshold amplifier 1008. The output of the operational amplifier 1010 is coupled to a third input 1024 of the threshold amplifier 1008. The output 1020 of the threshold amplifier 1008 is coupled to an input of the comparator 1004.

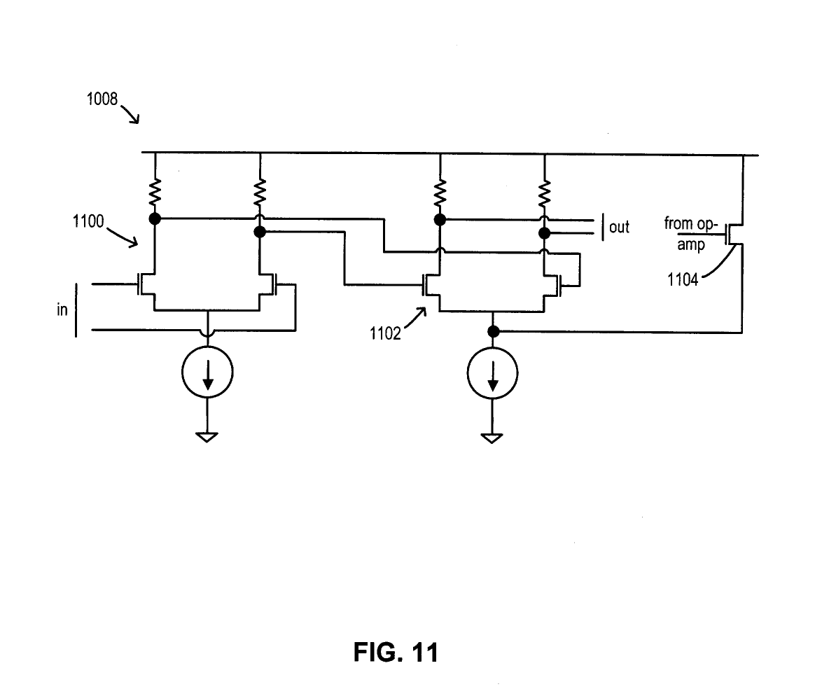

FIG. 11 is a schematic circuit diagram that illustrates the threshold amplifier 1008 that is part of the LOS detector 204a of FIG. 10. The threshold amplifier 1008 includes an input stage 1100 and an output stage 1102 that is coupled to the input stage 1100. The threshold amplifier also includes a transistor 1104 which is coupled between the power supply and the tail of the output stage 1102 with the gate of the transistor 1104 being coupled to the output of the operational amplifier 1010 (FIG. 10).

As in the LOS detector 204 of FIG. 4, the presence of the threshold amplifier 1008 in the LOS detector 204a allows for compensation for variations in the gain of the input amplifier 1000. In addition, the arrangement of FIG. 10 tends to minimize the effect of offsets.

The operational amplifier functions to cause offsets in the input branch of the LOS detector 204a also to be present in the threshold branch, so that such offsets are cancelled at the comparator 1004. Further, the components of the threshold branch itself are configured to minimize the offsets of those components.

Cancellation of the input branch offsets will now be briefly described.

The DC portion of the signal at node 1026 (output of the input amplifier 1000) may be expressed as V₁=(A*Vᵢₙ_{_{—}}_{offset})+V_{DC}, where A is the gain of the input amplifier 1000, Vᵢₙ_{_{—}}_{offset} is the input referred offset of the input amplifier 1000, and V_{DC} is the DC component of the signal at node 1026 other than the amplified offset.

The DC level V₁ is applied to input 1028 of the operational amplifier 1010 via the lowpass filter 1012. Since the other input 1030 of the operational amplifier 1010 is coupled to node 1014 (between resistors 1016, 1018 at the outputs of the threshold amplifier 1008), the level at node 1014 is forced to be substantially V₁.

The signal level V₂ at the output 1020 of the threshold amplifier 1008 can be expressed as:

V₂=((½)*A*(V_{TH}+V_{TH}_{_{—}}_{offset}))+V₁

where A is the gain of the threshold amplifier 1008 (being substantially the same as the gain of the input amplifier 1000), V_{TH} is the threshold level output from the threshold generator 1006, and V_{TH}_{_{—}}_{offset} is the offset of the threshold amplifier 1008 (it is assumed that the values of resistors 1016 and 1018 are substantially equal). The resistors 1016 and 1018 have rather large values so that the resistors 1016, 1018 do not affect the gain of the threshold amplifier 1008 and so that the node 1014 represents the common mode voltage of the outputs 1020, 1022 of the threshold amplifier 1008.

V_{TH}_{_{—}}_{offset} can be minimized by increasing the size of the devices which make up the threshold generator 1006 and the threshold amplifier 1008. Consequently, the signal provided to the comparator 1004 from the threshold branch of the LOS detector 204a is substantially equal to:

((½)*A*V_{TH})+V₁

The signal provided to the comparator 1004 from the input branch of the LOS detector 204a is substantially the peak of the RF component of the amplified input signal plus V₁. Thus V₁ is cancelled at the comparator 1004, which compares the peak of the RF component of the amplified input signal with one-half of the amplified threshold signal.

The offset of the threshold generator 1006 and the threshold amplifier 1008 are minimized by increasing the size of the components of the threshold generator and the threshold amplifier. As noted above, the threshold amplifier 1008 is also configured to track the gain of the input amplifier 1000.

For each stage of the input and threshold amplifiers, the gain of the stage is the product of the transconductance gₘ and the load resistance R. The transconductance gₘ is proportional to the square root of (I*(W/L)), where I is the current, W is the gate width, and L is the gate length.

Let Rᵢₙ be the load resistance for a stage of the input amplifier 1000, Iᵢₙ be the current for the stage, and Wᵢₙ and Lᵢₙ the width and length, respectively, of the transistors of the stage. Then, for the corresponding stage of the threshold amplifier 1008, the current is reduced to Iᵢₙ/M, the load resistance is increased to M*Rᵢₙ, so that the voltage swing is maintained the same, the gate width is (N/M)*Wᵢₙ and the gate length is N*Lᵢₙ. In these expressions, M is the current ratio, and N is the size scaling factor. For example, N could be around 17, to produce substantially an increase in size (area) of about a factor of about 300. (Alternatively, the gate width for the corresponding threshold amplifier stage could be N*Wᵢₙ and the gate length could be N*M*Lᵢₙ) The current ratio M may be chosen such that the current consumption is low enough to satisfy device specifications while achieving gain tracking. For example, M may be in the range 2-10 depending of the specified accuracy of the threshold.

With this scaling in size of the threshold amplifier gain stages, the offset is minimized, while the gate configuration is such that the gain of the threshold amplifier stage tracks the gain of the corresponding stage of the input amplifier.

The LOS detectors disclosed herein may be implemented by using bipolar, CMOS or BiCMOS technology, for example. To provide only one possible example, in some embodiments the input amplifier 1000, the threshold amplifier 1008 and the peak detector 1002 may be formed of bipolar devices for fast response, while the operational amplifier 1010, the threshold generator 1006, and the comparator 1004 may be formed of CMOS devices.

Thus, in some embodiments, an input signal is amplified by a first amplifier and a peak level of the amplified input signal is detected. A threshold signal is generated and is amplified by a second amplifier. The peak level of the amplified input signal is compared with the amplified threshold signal to detect loss of the input signal. The second amplifier may be arranged to track the gain of the first amplifier, so that costly compensation arrangements such as an off-chip variable resistor can be dispensed with.

The several embodiments described herein are solely for the purpose of illustration. The various features described herein need not all be used together, and any one or more of those features may be incorporated in a single embodiment. Therefore, persons skilled in the art will recognize from this description that other embodiments may be practiced with various modifications and alterations.

What is claimed is:

1. An apparatus comprising:
a first amplifier capable of receiving an input signal and outputting an amplified input signal;
a peak detector coupled to the first amplifier to receive the amplified input signal and capable of outputting a first signal that represents a peak level of the amplified input signal;
a threshold generator capable of generating a threshold signal;
a second amplifier coupled to the threshold generator to receive the threshold signal and capable of outputting an amplified threshold signal; and
a comparator coupled to the peak detector and to the second amplifier and capable of comparing the first signal to the amplified threshold signal.

2. The apparatus of claim 1, wherein the first and second amplifiers are both formed on the same semiconductor die, the second amplifier being configured to substantially match a gain of the first amplifier.

3. The apparatus of claim 2, wherein the peak detector, the threshold generator and the comparator are all formed on the same semiconductor die with the first and second amplifiers.

4. The apparatus of claim 2, wherein each of the first and second amplifiers is formed from cascaded differential pairs.

5. The apparatus of claim 2, wherein at least one of the first and second amplifiers, the peak detector, the threshold generator and the comparator includes at least one CMOS field effect transistor.

6. The apparatus of claim 1, wherein the comparator includes an operational amplifier.

7. The apparatus of claim 1, wherein the peak detector includes:
a first balanced differential pair;
a second balanced differential pair coupled to the first balanced differential pair;
an unbalanced differential pair coupled to the second balanced differential pair;
a final stage differential pair coupled to the unbalanced differential pair; and
a capacitor coupled to the final stage differential pair.

8. The apparatus of claim 1, wherein the first amplifier includes at least one stage of a transimpedance amplifier or of a limiting amplifier.

9. The apparatus of claim 1, wherein the apparatus is formed using at least one of bipolar, CMOS and BiCMOS technology.

10. An apparatus comprising:
a photodiode capable of being coupled to an optical fiber to receive an optical input signal and to generate an electrical input signal;
a receive amplifier coupled to the photodiode; and
a loss-of-signal detector coupled to the photodiode;
wherein the loss-of-signal detector includes:
a first amplifier coupled to the photodiode and capable of receiving the electrical input signal and outputting an amplified input signal;
a peak detector coupled to the first amplifier to receive the amplified input signal and capable of outputting a first signal that represents a peak level of the amplified input signal;
a threshold generator capable of generating a threshold signal;
a second amplifier coupled to the threshold generator to receive the threshold signal and capable of outputting an amplified threshold signal; and
a comparator coupled to the peak detector and to the second amplifier and capable of comparing the first signal to the amplified threshold signal.

11. The apparatus of claim 10, wherein the first and second amplifiers are both formed on the same semiconductor die, the second amplifier being configured to substantially match a gain of the first amplifier.

12. The apparatus of claim 11, wherein the peak detector, the threshold generator and the comparator are all formed on the same semiconductor die with the first and second amplifiers.

13. The apparatus of claim 11, wherein each of the first and second amplifiers is formed from cascaded differential pairs.

14. The apparatus of claim 11, wherein at least one of the first and second amplifiers, the peak detector, the threshold generator and the comparator includes at least one CMOS field effect transistor.

15. The apparatus of claim 10, wherein the comparator includes an operational amplifier.

16. The apparatus of claim 10, wherein the peak detector includes:
a first balanced differential pair;
a second balanced differential pair coupled to the first balanced differential pair;
an unbalanced differential pair coupled to the second balanced differential pair;
a final stage differential pair coupled to the unbalanced differential pair; and
a capacitor coupled to the final stage differential pair.

17. A method comprising:
receiving an input signal;
amplifying the input signal to provide an amplified input signal;
detecting a peak of the amplified input signal to provide a first signal that represents a peak level of the amplified input signal;
generating a threshold signal;
amplifying the threshold signal to provide an amplified threshold signal; and
comparing the first signal to the amplified threshold signal.

18. The method of claim 17, further comprising:
detecting an interruption of the input signal on the basis of a result of comparing the first signal to the amplified threshold signal.

19. The method of claim 18, further comprising:
supplying the input signal to a serializer/deserializer.
